(19) United States
(12) Patent Application Publication
(10) Pub. No.: US 2024/0173601 A1
(43) Pub. Date: May 30, 2024

(54) Golfing Location and Communication Application

(71) Applicant: Kyle Thomas Carver, Berthoud, CO (US)

(72) Inventor: Kyle Thomas Carver, Berthoud, CO (US)

(21) Appl. No.: 18/521,986

(22) Filed: Nov. 28, 2023

Related U.S. Application Data
(60) Provisional application No. 63/385,140, filed on Nov. 28, 2022.

(51) Int. Cl. A63B 57/00; H04M 1/72427; H04M 1/72457

(52) U.S. Cl. CPC A63B 57/00; H04M 1/72427; H04M 1/72457

(57) ABSTRACT

Disclosed is a system and method for managing the flow and play rates of multiple groups on a golf course. Specifically, the system and method utilize a digital platform to facilitate communication between groups and manage gameplay. In particular, the invention provides a system to standardize requests for playthroughs. Groups are incentivized into accepting such requests through a “karma” system, refreshments from the requesting group, and other reward systems. Additionally, the system allows for other features which aid in managing the pace of play across the course.

### FIELD OF THE INVENTION

The present invention relates generally to software and hardware systems and methods. Specifically, the present invention is a software system with hardware components intended to facilitate the play and management of the sport of golf.

### BACKGROUND OF THE INVENTION

Golf is a sport that requires a great deal of time to play and takes place over sprawling courses. A standard round of golf can take around four and a half hours, varying upwards or downwards depending on the pace of play. This can create issues when multiple parties of players are using a given golf course at the same time, which leads to bottlenecking when faster groups are stuck behind a slower group. A slow pace of play is one of the leading complaints about the sport heard in the golf community. While it is possible for a player to directly request for another group to step aside to let the current group “play through” them onto the next hole, this can often result in uncomfortable direct confrontation between the two groups and results in a distraction from the game for both groups of players. Some golf courses hire marshals to patrol the course and ensure groups are playing expediently, but marshals are an expensive and often ineffective solution to this problem, as such marshals may also avoid direct confrontation or simply wish to avoid disturbing the paying customers on the course, leading them to avoid asking groups to speed up their pace of play.

An objective of the present invention is to provide the appropriate hardware and software to create an application allowing for remote management, communication, and connection between any players on a golf course, as well as to connect and inform management overseeing the golf course. To that end, the present invention comprises a software application that allows users to track their location on the course, track the location of the parties playing directly in front of and behind them, and to communicate with those players. Communication is kept to standard requests and phrases to avoid unnecessary confrontation and hostility between golf groups. For example, a group may submit a standardized request to “play through” a group in front of them. In order to facilitate peace of mind, users of the application may be associated with user accounts that can keep track of their “golf karma” score. Such a score may increase when a group allows others to play through them, purchases a round of drinks for other players, plays at a suitable pace, or may be associated with a rating system. This can reward considerate players for being polite and allowing other groups to play through them, and can give any group asking to play through the peace of mind that they are dealing with a polite and considerate player. Further, the application can allow the submission of drink requests to a beverage cart, or other requests can be submitted to the golf pro shop. As the application allows for location tracking, any requested beverages, golf equipment, or other forms of assistance can be delivered directly to the players on the course without interrupting the flow of play. In this way, the present invention greatly facilitates and expedites the pace of play of the sport of golf while reducing costs and overhead, and enables players to have a sense of security and comfort to play at their desired pace. This will further increase throughput for golf courses and increase income by allowing more groups to use the golf course on a given day.

### BRIEF DESCRIPTION OF THE DRAWINGS

FIG. 1 is a diagram showing examples of multiple different types of console connecting to the digital software platform through a network according to an embodiment.

FIG. 2 is a diagram showing examples of consoles with location data and a pair of specially designated consoles communicating through the digital software platform and network according to an embodiment.

FIG. 3 is a functional map describing the software application and its implementation on one or more consoles according to an embodiment.

FIG. 4 is a flow diagram describing a potential use case pattern according to an embodiment.

FIG. 5 is a flow diagram demonstrating a potential service request and reward experience for a play group according to an embodiment.

### DETAILED DESCRIPTIONS OF THE INVENTION

All illustrations of the drawings are for the purpose of describing selected versions of the present invention and are not intended to limit the scope of the present invention.

The present invention comprises a console, a digital platform, and a social platform.

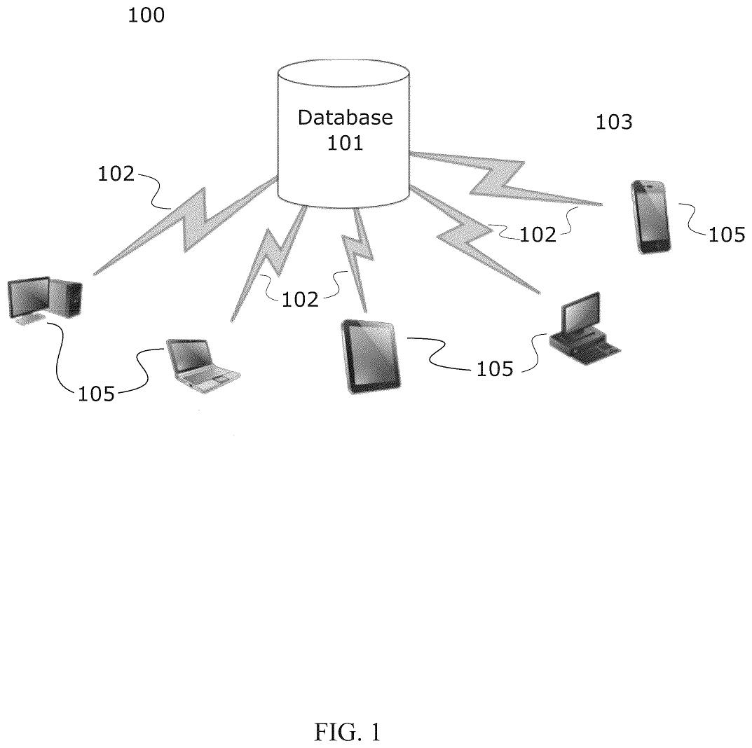

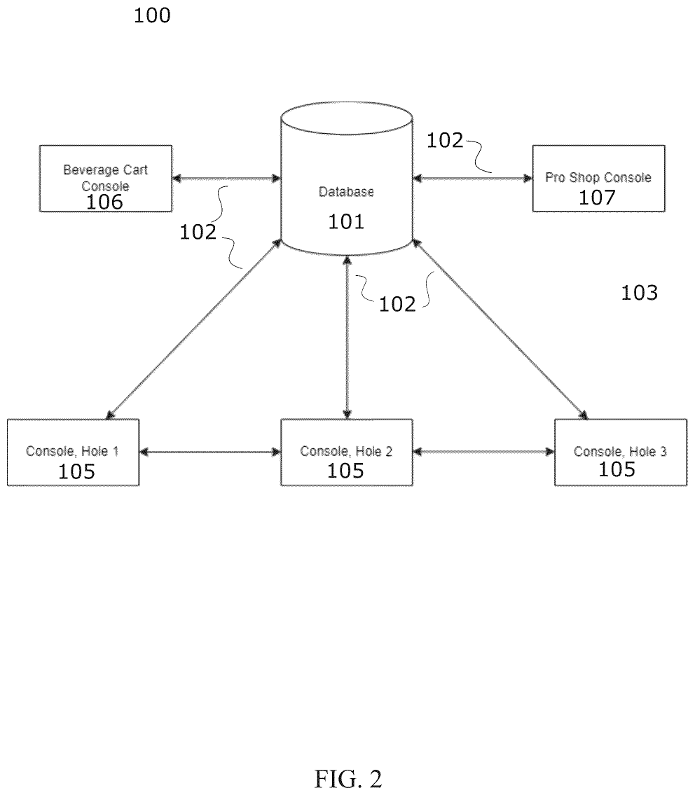

As demonstrated by FIGS. 1 and 2, the digital application platform 100 comprises a database 101, a network 102, and a software application 103. In the demonstrated embodiment, software application 103 is operating on a number of consoles 105 configured to operate the application. In some embodiments, the database 101 may be distributed throughout the consoles or may reside within a single console that functions as a server. In other embodiments the server may not have console functionality, where its data is managed remotely through the software application via the network. FIG. 2 describes a further embodiment where a specialized service console 106 (described as a beverage cart) and an administrative console 107 (described as a pro shop console) are incorporated into the software application platform 103.

The software application comprises a location detection service, a user account management system, a messaging system, and a network connection. FIG. 2 shows an overview of the components associated with the software application.

As seen in FIG. 1, the database and network connection allow communication between all instances of the software application and any consoles or tablets. Consoles or tablets may communicate with each other either over a local network to share information, or information may be hosted on a centralized database, each console or tablet interfacing with the database to send and retrieve information. Information may be sent and received by any competent wireless technology, such as but not limited to: Bluetooth, Internet Protocol and Transmission Control Protocol Packets, cellular data, or any similar technology enabling wireless transfer of information between electronic devices.

Each console may be a dedicated console, a tablet, a phone, or any suitable mobile device. The console further comprises geolocation hardware, a wireless communications technology, a data storage medium, a display, and a processing unit. Consoles may be provided to users at a course as portable items, or may be affixed to golf carts, beverage carts, or other fixtures throughout the golf course as necessary to allow appropriate communication between them.

The locations services hardware keeps track of the spatial location of the console, such as by using GPS capabilities or other geolocation technology such as technology that is built-into modern SIM cards in phones. In this way, each console keeps track of the console's own location. Each console then sends the console's own location information to either the central server or to all other consoles on the network, depending on the embodiment. This information is then distributed to every relevant console using the wireless communications technology, and then each console stores that information in the data storage medium, which may comprise any digital data storage mechanism such as a hard drive.

The processing unit includes a central processing unit or similar calculator, and may be used to perform any transmutations, calculations, or other necessary processing on the location data. All relevant location data can be displayed in a visually succinct manner as needed, such as by using the central processing unit to align the location data on a map and display the map and location data on the console's display for ease of reference.

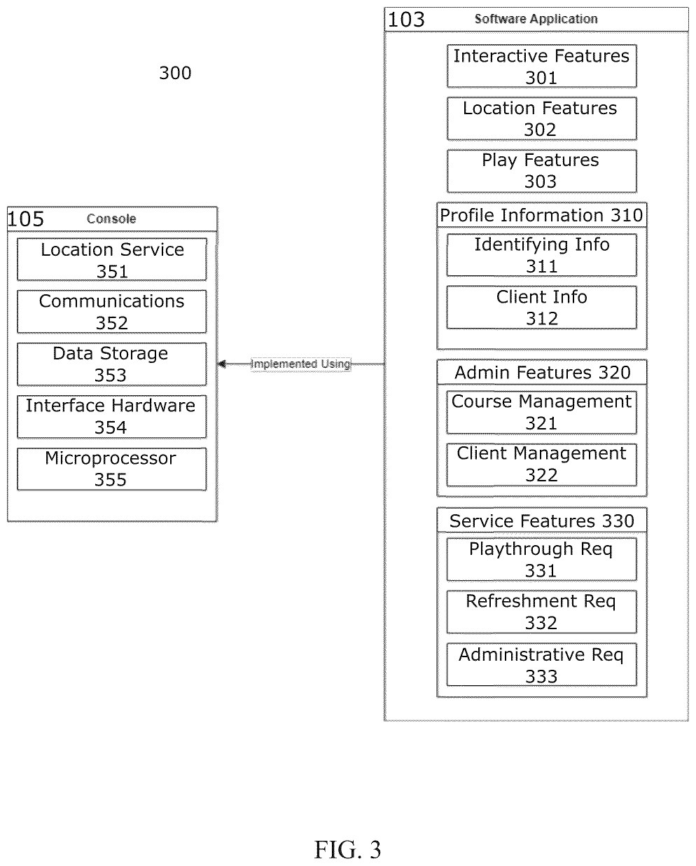

The software application makes use of the above data and hardware to perform a variety of functions. The software application can allow for messaging functionality, response functionality, golfer profile functionality, location display functionality, round tracking functionality, course management functionality, and management of user accounts. FIG. 3 provides an overview of the functionality of the software application and the supporting hardware and software located within the console.

In the embodiment described through FIG. 3, we see a console 105 implementing the software application 103 as an element 300 of the digital application platform. Embodiments of the software application 103 include a number of core features 301, 302, and 303 to aid gameplay and course-flow. The interactive features 301, includes the ability to message other consoles 105, typically through the service features 330. This would typically include the ability to issue or respond to a playthrough request 331, to request refreshments (332) from a console equipped to service such requests, and/or to respond to administrative requests 333 to allow others to playthrough. Some embodiments may allow a user to make administrative requests 333 such as purchasing replacement equipment from the pro shop or calling for some form of medical assistance. Embodiments may also allow a refreshment request 332 to be made on behalf of another console. Some embodiments may also allow for messaging between consoles related to the course, hole, weather, or other relevant categories that can help manage the course. Embodiments of the invention also consider tracking the location (302) of the consoles throughout the course. Embodiments of this feature may allow for a visual display of the locations of consoles 105 on the course. Some embodiments may limit the display to only those consoles 105 which are nearby while others may limit the location display to an admin console 107, also identifiable as a console 105 with access to admin features 320. Play features 303 round out the core software application 103 available to most users. These functions serve to provide minor gameplay aids to groups, such as scoresheets or hole information. Some embodiments may allow for a virtual caddy to help in club decisions. Other embodiments may display wind and weather information captured from the sensors of a digitally connected course.

FIG. 3 also describes some of the underlying organizational elements of the digital application platform. When assigned to a group, the console 105 would be associated with the profile(s) 310 of one or more clients in the assigned group. This information would typically include identifying information 311 of those clients, such as contact information. Additionally, some embodiments would also include some information specific to the client's relationship with the course or organization (312). This sort of information could include data such as membership status, a tab with any refreshment service or the pro shop, karma points or other rewards for allowing playthroughs and otherwise playing at a good pace. Other embodiments may include data such as handicaps, average course play rates, marketing preferences, or disciplinary notes. Administrative features 320 would allow for certain associated consoles or user profiles to manage the system. In particular, course management 321 features would allow an administrator to issue communications on behalf of other consoles 105, directly issue playthrough requests 331, manage refreshment workflow (332), override the responses to various requests, issue warnings such as weather or health alerts, and other actions that would conceivably be part of a course manager's responsibility or authority. Further, the admin features 320 would allow for management of clients 322. This would include creation or modification of user profiles, adjustment of karma points or other rewards, tracking play and spending trends, or otherwise providing information for managing the client.

In this embodiment, each console 105 implementing the software application 103 is comprised of several necessary capabilities. Each console 105 includes a location service 351 enabling the digital application platform to track and locate the console 105. The location capabilities 351 of each console may be achieved using software, hardware, or some combination thereof. The console employs communications hardware 352 to utilize the network 102, allowing it to transmit location data (351) and interact with other consoles 105 as a part of the software application's 103 interactive 301 or admin features 320. Non-transitory data storage 353 allows a console 105 to record game data and store relevant information for the current group associated with the console 105. Interface hardware 354 is necessary to allow the console to perform input and output activities required by the software application 103. This hardware typically includes a screen for visual display and a touch interface. Some embodiments may allow for microphones and speakers to be included. Other embodiments may include a physical keyboard and/or mouse in-lieu of or to supplement a touch interface. The interface hardware 354 enables the console 105 to implement the features of the software application 103, including issuing and responding to service features 330. A microprocessor 355 allows for much of the computational work to be done on the console 105. Some embodiments may consider distributing the workload of one or more consoles 105 across the network. Another embodiment may consider implementing a notification system to indicate whether a console is communicating through the digital application platform properly.

The software application may retrieve or receive geolocation data from other consoles, then use the processing unit to perform calculations to determine which other groups using the course are in front of and behind the current group. In one embodiment, the software application may track this geolocation data, map the geolocation data to the golf course layout, and subsequently notify the current group that they are clear to tee off when the next group on the course has reached a suitable distance. A beverage shop or golf pro shop may use this geolocation data to track locations to assist in delivering any requested beverages, equipment, or other items. Any other similar use or processing of the geolocation data is considered contemplated by the current invention.

The messaging functionality comprises the ability to send messages between two or more consoles. For example, a user may send a message to a group playing in front of the user to ask permission to play through the group, or may ask the group playing behind the user if the group behind the user would like to play through. The group that receives the message will be prompted to either decline the request or accept the request through the response functionality. Further, a user may send a message to the beverage cart to request a drink, or send a request to the pro shop to request equipment or assistance. In one embodiment, users may send a message directly to the beverage cart to request a round of drinks for another group using the course. The administrator or golf course owner may monitor the locations of consoles on the course using the collected geolocation technology and send messages to consoles on the course to request a playthrough for another group. The administrator or golf course owner may then decide to award karma if the group accepts the request—see the following paragraph for more information on the karma system.

The golfer profile functionality allows user accounts to be created and tied to specific users, forming the basis for the social platform. Such a user account may comprise any basic biographic information about the user, alongside a golf karma score. The golf karma score may be calculated by a variety of factors, or may be manually entered and adjusted by the golf course owner. Golf karma score factors may be adjusted for approving requests to play through, instituting a request to purchase drinks, keeping a good pace of play, being rated by fellow users, or any other factor that may be relevant. The golf karma score may reflect the golfer's willingness to let others play through them on the course, or may reflect general compassion and kindness to fellow golfers. The score may be publicly displayed to other golfers, or displayed to the golfers currently behind and ahead of the golfer on the course. Other golfers may reference this information when deciding whether to create a request to play through the golfer, to allow the golfer to play through them, or to allow golfers to make more informed decisions in partner choice. Any information related to the karma calculations may be adjusted accordingly by the administrator or golf course owner to promote the help promote the desired style of play for that specific golf course. In one embodiment, the golfer profile may further comprise payment information or payment credit information to enable purchase requests to be submitted with the corresponding payment to the pro shop, beverage cart, or other point of sale system.

The location display functionality makes use of the display and central processing unit of the console. As described above, all relevant location data that is received via the wireless communications technology can be displayed in a visually succinct manner as needed, such as by using the central processing unit to align the location data on a map and display the map and location data for the user for ease of reference. The exact or estimated distance between the user and other nearby users on the course may be displayed to help users adjust their pace of play accordingly.

Round tracking functionality is further included in the software application to help users manage and track scores, holes, par information, and any other relevant information. The round tracking functionality may include a digital scorecard.

The software application further comprises course management functionality. The course management functionality may be restricted in access to only the administrator or golf course owner. The course management functionality comprises a means to display all locations of current users and other consoles, and may include a list of pending or completed requests. The course management functionality further comprises the ability of the administrator or golf course owner to send requests or messages to any individual console or user.

Each console may further comprise a self-check light. The self-check light may turn red or green depending on whether the system is currently experiencing an error or functioning properly, respectively. The system self-check light may be integrated into the software application, allowing the self-check light to be manipulated accordingly by the software application. The software application may use the processing unit of the console to access information regarding network status, power and battery status of the console, and to run any other relevant diagnostics and display those errors via the self-check light.

In one embodiment, the console may be built into an existing structure or object, such as being integral to a beverage cart placed physically within a golf shop. In other embodiments, the console may be a portable tablet, phone, or monitor that can be easily stored or transported throughout the golf course area. In one embodiment, the console may be a dedicated portable digital monitor, which further comprises a means for mounting the monitor on a golf cart, and a battery or solar power source. Such a dedicated portable digital monitor will have the software built-in, enabling a golf shop to easily rent or lend the consoles to golfers, obviating the need for golfers to install an application on their own mobile devices.

The software application further comprises functionality for the management of user accounts. The administrator or golf course owner may adjust information, karma scores, and any other relevant data present on the user accounts. The administrator or golf course owner may further delete user accounts, add user accounts, or otherwise modify user accounts.

In one embodiment, the flow of information to a console may be intentionally restricted to only display the groups in front of and behind the current group. This prevents needless display of information and reduces network traffic.

The server may keep track of a list of all pending requests. In one embodiment, the software application may display the current queue of all pending requests to allow a user to see their position in line. The user may further see the location of the beverage cart displayed. This information allows a user to roughly estimate the time it will take for their order to be processed and receive the items in the request.

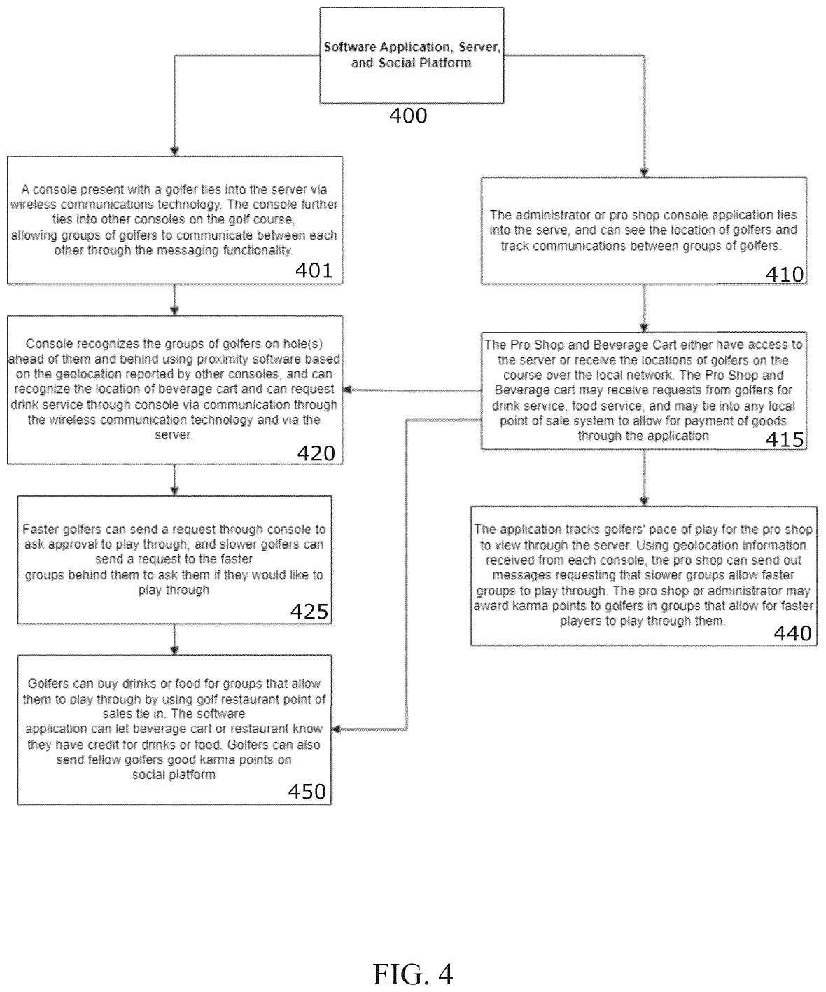

FIG. 4 describes an example operational flow according to an embodiment. Here, an instance of the software application 400 connects to the digital platform either as a play group console (401) or an administrator (410). When operating as a play group (401), the console allows access to the play features of the software application and interact with other play groups (401) throughout the course. With the system tracking the location of each group (420), it would also be able to provide information on proximity of other groups or the drink card. Should the play group overtake or be overtaken by another group, the console would recognize the situation and provides playthrough request options (420) to the affected groups. This allows the faster group to request a playthrough or the slower group to offer a playthrough (425). The system would then encourage groups to buy each other refreshments or otherwise reward the gracious group with things like karma points (450). For the administrative flow path, an administrator (410) can monitor the course, including locations and communications. They can monitor and respond to refreshment and other sales requests (415). Additionally, they can use their own judgment or experience to check whether groups may be interested in refreshments (420) or issue playthrough requests and notifications on behalf of one or another group (450). Because the system tracks rate of play, the administrator may also elect to send out messages requesting more playthroughs by slower groups (440) based on this information. An administrator would also have the option to manually adjust karma points where groups are more generous in allowing playthroughs (440).

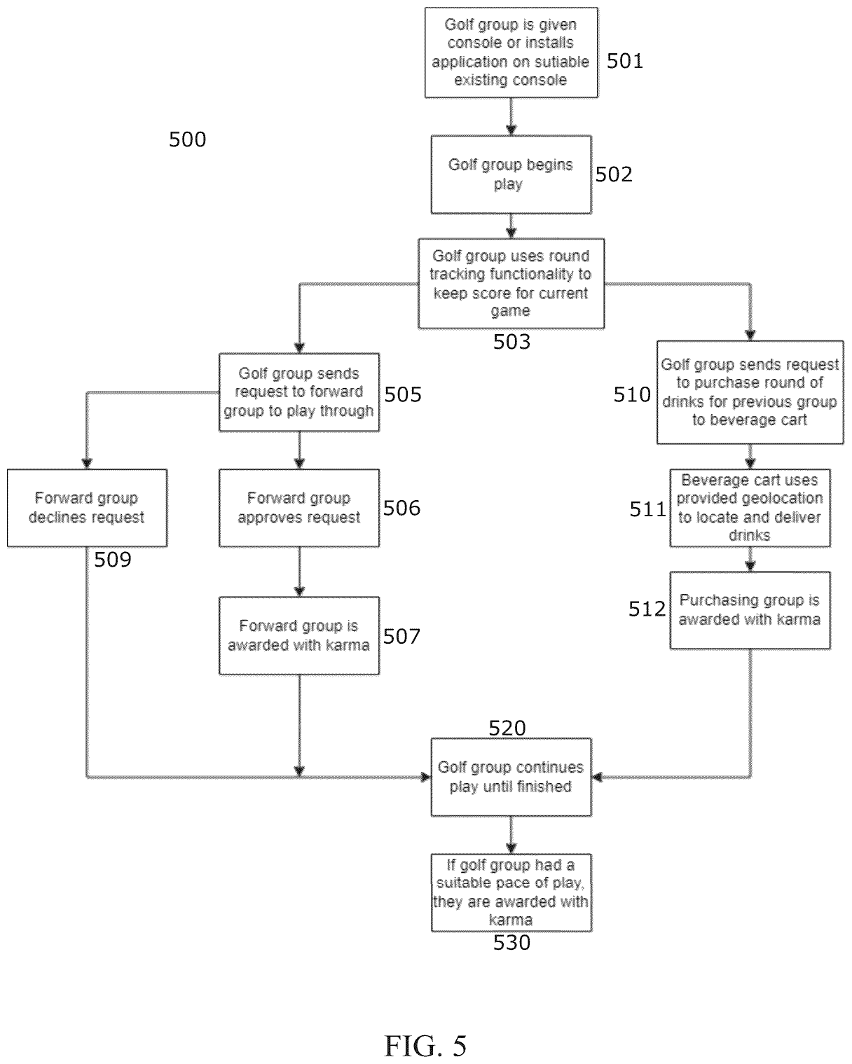

FIG. 5 provides some simplified example flows for a typical user according to an embodiment. Here we see a group (500) provided access to the digital platform through a console (501). The group begins play on the course (502) and utilizes the scorecard feature to manage scores of their group (503). In one path, the group comes upon a slower playing group and sends a playthrough request (505). If the slower group accepts the request (506) they would be rewarded with karma (507). The group may also decline the request (509). In either case, the group would continue playing until finished (520). On another path, the group would issue a request to purchase drinks for another group that allowed a playthrough (510). The system would use its tracked location information to deliver the drinks (511) and the purchasing group would be issued karma (512). The group would then proceed to play until the course was completed (520). In any case, one the course was completed a group that meets a threshold for pace of play could also be awarded additional karma (530).

Although the invention has been explained in relation to its preferred embodiment, it is to be understood that many other possible modifications and variations can be made without departing from the spirit and scope of the invention.

1. A method of managing play rates and flow for a golf course, comprising:
providing a digital application platform comprising a software application, a network, and a database;
providing one or more consoles each comprising a computing device, non-transitory storage media, interface hardware, and communications hardware;
configuring the one or more consoles to communicate using the digital application platform by executing the software application;
associating at least one of the one or more consoles with a group of one or more players;
transmitting the location of the group-associated consoles via the network;
storing the locations of the group-associated consoles within the database;
providing a user input on a console via the software application requesting a service through the digital application platform;
receiving a service request through the digital application platform;
providing a user response to a service request on a console via the software application through the digital application platform.

2. The method of claim 1, wherein the digital application platform further comprises a server and the database is stored on non-transitory digital media within the server.

3. The method of claim 1, wherein the service requested by the provided user input is sent to a specific console associated with a group of one or more players selected as a part of the provided user input, the service request is only received by the selected console, and the user response must be provided by the selected console.

4. The method of claim 3, wherein the specified console is associated with a group of one or more players that are ahead of you and the service requested is for your group to play-through the hole;

5. The method of claim 3, wherein the specified console is associated with a group of one or more players that are behind you and the service requested is to request whether their group would like to play-through the hole;

6. The method of claim 3, wherein one or more responses to the service request are associated with one or more rewards and the selected console is provided the rewards associated with their response.

7. The method of claim 1, wherein another one or more consoles is associated with a mobile refreshment unit, the service requested by the provided user input is sent to the mobile refreshment unit console, the service request is only received by the mobile refreshment unit console, and the mobile refreshment unit console provides the response to the service request.

8. The method of claim 7, wherein the requested service can include providing refreshment to one or more other consoles associated with groups of one or more players selected during the user input.

9. The method of claim 1, wherein another one or more consoles is associated with an administrator of the digital application platform.

10. The method of claim 9, wherein the one or more consoles associated with an administrator is provided with an overview of all user inputs, service requests, and user responses within the digital application platform.

11. The method of claim 10, wherein the one or more consoles associated with an administrator may issue a service request on behalf of one or more other consoles.

12. A system for managing play rates and flow for a golf course, comprising:
a digital application platform comprising a software application, a network, and a database;
one or more consoles each comprising a computing device, non-transitory storage media, interface hardware, and communications hardware;
the one or more consoles being configured to communicate using the digital application platform by executing the software application;
at least one of the one or more consoles is associated with a group of one or more players;
each of the one or more consoles continuously transmitting its location to the software application platform via the network;
wherein the locations of the group-associated consoles are stored within the database;
wherein the user may request a service by user input on a console via the software application through the digital application platform;
wherein the requested service is received through the digital application platform;
wherein a user may respond to a received service request on a console via the software application of the digital application platform.

13. The system of claim 12, wherein the digital application platform further comprises a server and the database is stored on non-transitory digital media within the server

14. The system of claim 12, wherein the service requested by the user is sent to a specific console associated with a group of one or more players selected during user input, the service request is only received by the selected console, and only a user of the selected console may respond to the request.

15. The system of claim 12, wherein another one or more consoles is associated with a mobile refreshment unit, a user may choose the mobile refreshment unit when requesting services, the service request is only received by the mobile refreshment unit console, and only the mobile refreshment unit console may provide a response to the service request.

16. The system of claim 15, wherein the requested service may include delivery of refreshments to one or more chosen consoles associated with groups of one or more players.

17. The system of claim 12, wherein another one or more consoles is associated with an administrator of the digital application platform.

18. The system of claim 17, wherein the one or more consoles associated with an administrator is provided with an overview of all user inputs, service requests, and user responses within the digital application platform.

19. The system of claim 18, wherein the one or more consoles associated with an administrator may issue a service request on behalf of one or more other consoles.

20. A system for managing play rates and flow for a golf course, comprising:
a digital application platform comprising a software application, a network, a digitally connected golf course, and a database;
one or more consoles each comprising a computing device, non-transitory storage media, interface hardware, and communications hardware;
the one or more consoles being configured to communicate using the digital application platform by executing the software application;
at least one of the one or more consoles is associated with a group of one or more players;
each of the one or more consoles continuously transmitting its location to the software application platform via the network;
wherein the locations of the group-associated consoles are stored within the database;
wherein the user may request a service by user input on a console via the software application through the digital application platform;
wherein the requested service is received through the digital application platform;
wherein a user may respond to a received service request on a console via the software application of the digital application platform;
wherein the digitally connected golf course comprises sensors, one or more computing devices, and communications hardware;
wherein the digitally connected golf course is configured to provide sensor data to the digital application platform by communicating over the network.
